(19) United States
(12) Patent Application Publication
(10) Pub. No.: US 2020/0340955 A1
(43) Pub. Date: Oct. 29, 2020

(54) DIRECT SEQUENCE SPREAD SPECTRUM CODED WAVEFORMS IN ULTRASOUND IMAGING

(71) Applicant: Decision Sciences Medical Company, LLC, Poway, CA (US)

(72) Inventor: Allan Wegner, Del Mar, CA (US)

(21) Appl. No.: 16/857,123

(22) Filed: Apr. 23, 2020

Related U.S. Application Data
(60) Provisional application No. 62/837,720, filed on Apr. 23, 2019.

(51) Int. Cl. G01N 29/46; G01N 29/07; G01N 29/50; G01N 29/38

(52) U.S. Cl. CPC G01N 29/46; G01N 29/07; G01N 2291/269; G01N 29/38; G01N 29/50

(57) ABSTRACT

Techniques, structures, and systems are disclosed for ultrasound imaging using direct sequence spread spectrum (DSSS) coded waveforms. In one aspect, a method f includes synthesizing individual DSSS waveforms each having a unique set of one or more frequencies with respect to each other; generating a composite waveform for transmission toward a material of interest by compiling two or more of the synthesized individual DSSS waveforms; producing and transmitting a composite acoustic beam based on the generated composite waveform toward the material of interest; receiving returned acoustic waveforms that are returned from at least part of the material of interest corresponding to at least some transmitted acoustic waveforms that form the composite acoustic beam; and processing the received returned acoustic waveforms to produce a data set containing information of the material of interest.

### CROSS-REFERENCE TO RELATED APPLICATIONS

This patent document claims priorities to and benefits of U.S. Provisional Patent Application No. 62/837,720 titled “DIRECT SEQUENCE SPREAD SPECTRUM CODED WAVEFORMS IN ULTRASOUND IMAGING” filed on Apr. 23, 2019. The entire content of the aforementioned patent application is incorporated by reference as part of the disclosure of this patent document.

### TECHNICAL FIELD

This patent document relates to systems, devices, and processes that use ultrasound imaging.

### BACKGROUND

Ultrasound imaging is an imaging modality that employs the properties of sound waves traveling through a medium to render a visual image. Ultrasound imaging has been used as an imaging modality for decades in a variety of biomedical fields to view internal structures and functions of animals and humans. Ultrasound waves used in biomedical imaging may operate in different frequencies, e.g., between 1 and 20 MHz, or even higher frequencies. Some factors including inadequate spatial and echo amplitude resolution can lead to less than desirable image quality using conventional techniques of ultrasound imaging, which can limit its use for many clinical applications.

### SUMMARY

Techniques, systems, and apparatuses are disclosed for ultrasound imaging using wide instantaneous bandwidth, direct sequence spread spectrum (DSSS), coherent, coded waveforms.

In some aspects, a method for acoustic imaging includes synthesizing individual direct sequence spread spectrum (DSSS) waveforms each having a unique set of one or more frequencies with respect to each other; generating a composite waveform for transmission toward a material of interest by compiling two or more of the synthesized individual DSSS waveforms; producing and transmitting a composite acoustic beam based on the generated composite waveform toward the material of interest, wherein the transmitting includes generating drive signals corresponding to the composite waveform to drive transducer elements of a transducer array to form the composite acoustic beam; receiving returned acoustic waveforms that are returned from at least part of the material of interest corresponding to at least some transmitted acoustic waveforms that form the composite acoustic beam; and processing the received returned acoustic waveforms to produce a data set containing information of the material of interest.

In some aspects, an acoustic imaging system includes a direct sequence spread spectrum (DSSS) waveform generator to generate a composite waveform comprising two or more individual DSSS waveforms, where each individual DSSS waveform includes a unique set of one or more frequencies with respect to each other; a waveform generation unit coupled to DSSS waveform generator, wherein the waveform generation unit produces and controls transmission of a composite acoustic beam based on the generated composite waveform toward a material of interest; an array of transducer elements in communication with the waveform generation unit to transmit the composite acoustic beam toward the material of interest and to receive returned acoustic waveforms returned from at least part of the material of interest, wherein the waveform generation unit is operable to control the transmission of the composite acoustic beam by generating drive signals corresponding to the composite waveform to drive transducer elements of the transducer array to form the composite acoustic beam; an array of at least one A/D converters that converts the received returned acoustic waveform received by the array of transducer elements from analog format to digital format as a received composite waveform comprising information comprising information of the material of interest; a data processing device including a controller unit in communication with the waveform generation unit and the array of at least one A/D converters, the data processing device comprising a processing unit that includes a processor and memory operable to process the received composite waveform to produce a data set containing information of the material of interest; and (optionally) a user interface unit in communication with the controller unit.

In some aspects of the disclosed technology, a method of creating an image from an acoustic waveform includes setting a transmit/receive switch into transmit mode, employing a stored DSSS composite waveform in one or more waveform synthesizers, transmitting an acoustic waveform based on the DSSS composite waveform toward a target, setting the transmit/receive switch into receive mode, receiving a returned echo (e.g., the acoustic waveform returned from at least part of the target area that is the tissue volume being studied), converting the received echo from analog format to digital format as a received composite waveform comprising information of the target area, and processing the received composite waveform to produce an image of at least part of the target area.

The subject matter described in this patent document can provide one or more of the following features and be used in many applications. For example, the disclosed technology can be used during routine primary care screenings to identify and locate early stage malignancies, as well as later stage cancers, which can potentially raise survival rates of hard to diagnose asymptomatic patients. The disclosed technology can be used by board certified radiologists to diagnose neoplasms as benign or malignant prior to any surgical biopsy or resection intervention, which may also improve patient survival rate while reducing unnecessary biopsies. The disclosed technology can, when integrated with a fine needle biopsy instrument, be used in medical procedures to confirm noninvasive diagnoses, which can reduce the level of invasiveness of such biopsy procedures. The disclosed technology can, when integrated with minimally invasive surgical high definition video instrumentation, fuse optical and ultrasound images, which can further give surgeons added abilities to locate and surgically excise diseased tissue without excising excessive healthy tissue. The disclosed technology can reduce the amount of time for the brachytherapy treatment of malignant neoplasms by, for example, precisely guiding the insertion of catheters and sealed radioactive sources into the proper location. Similarly, the disclosed technology can aid insertion of high dose, localized pharmaceuticals for treatments of diseases.

### BRIEF DESCRIPTION OF THE DRAWINGS

FIG. 1A shows a diagram of an example embodiment of a system for implementing direct sequence, spread spectrum, coded waveforms in ultrasound imaging.

FIG. 1B shows a chart for operation of an exemplary ultrasound imaging system using direct sequence, spread spectrum, coded waveforms.

FIGS. 2A-2D show diagrams illustrating example embodiments of methods for synthesizing direct sequence, spread-spectrum, coherent, coded composite waveforms.

FIG. 2E shows a block diagram depicting an example embodiment of a method for acoustic imaging using a direct sequence, spread spectrum, coded composite waveform generation technique in accordance with the present technology.

FIG. 3 shows a graph of an exemplary spread spectrum, wide instantaneous bandwidth, coded waveform featuring a plurality of tones.

FIGS. 4A-4C show an exemplary diagram for beam steering, dynamic focusing, and forming.

FIG. 5 shows an exemplary block diagram for correlation processing of a spread spectrum coded waveform.

Like reference symbols and designations in the various drawings indicate like elements.

### DETAILED DESCRIPTION

Techniques, systems, and apparatuses are described for generating, transmitting, receiving, and processing direct sequence spread spectrum (DSSS) coded waveforms used in ultrasound imaging.

Ultrasound imaging can be performed by emitting a time-gated, single frequency or a pulsed, carrier frequency (pulse) acoustic waveform, which is partly reflected from a boundary between two mediums (e.g., biological tissue structures) and partially transmitted. The reflection can depend on the acoustic impedance difference between the two mediums. Ultrasound imaging by some techniques may only use amplitude information from the reflected signal. For example, when one pulse is emitted, the reflected signal can be sampled continuously. In biological tissue, sound velocity can be considered fairly constant, in which the time between the emission of a waveform and the reception of a reflected signal is dependent on the distance the waveform travels in that tissue structure (e.g., the depth of the reflecting structure). Therefore, reflected signals may be sampled at multiple time intervals to receive the reflected signals being reflected from multiple depths. Also, different tissues at the different depths can (partially) reflect the waveform with different amounts of energy, and thus the reflected signal from different mediums can have different amplitudes. A corresponding ultrasound image can be constructed based on depth. The time before a new waveform is emitted can therefore be dependent of the maximum depth that is desired to image. Ultrasound imaging techniques employing pulsed monochromatic and/or narrow instantaneous bandwidth waveforms can suffer from poor resolution of image processing and production. Yet, waveforms with spread spectrum, wide instantaneous bandwidth characteristics that are can enable real-time control of ultrasound imaging and higher quality resultant images.

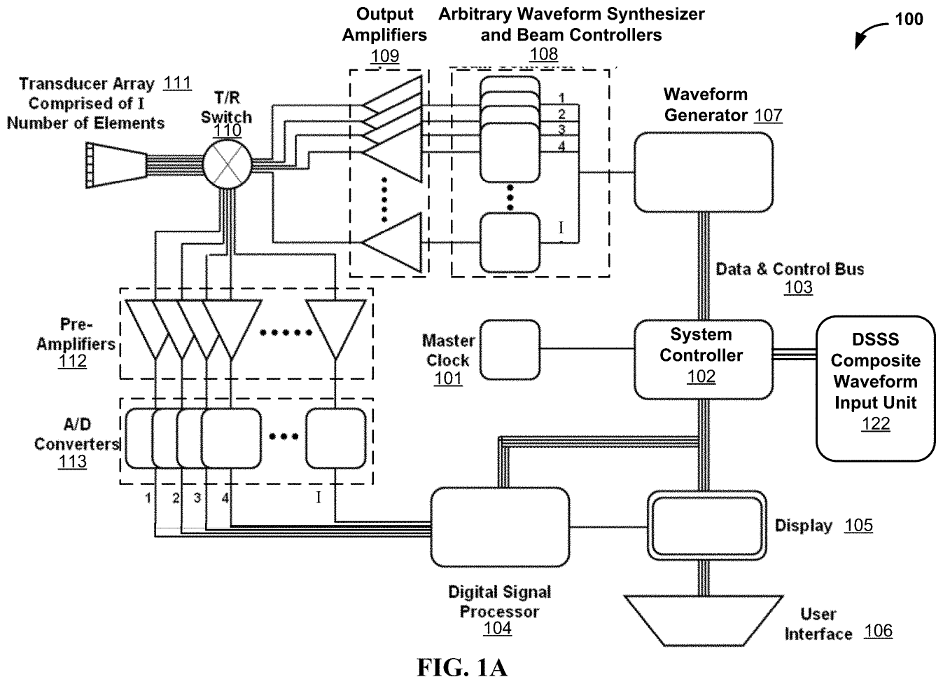

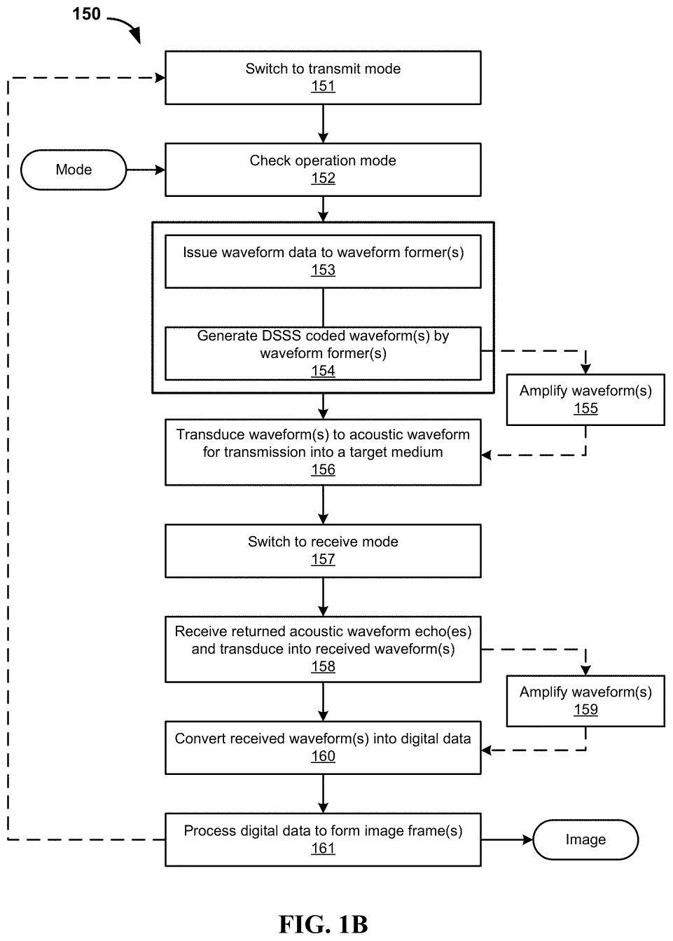

FIG. 1A shows a block diagram of an example embodiment of an ultrasound system 100 that can produce acoustic waveforms with enhanced waveform properties that include a coherent direct sequence spread-spectrum, wide instantaneous bandwidth, and coding. System 100 can be configured in one of many system designs. In the example shown in FIG. 1A, the system 100 includes a Master Clock 101 for time synchronization. The system 100 includes a System Controller 102 that can be interfaced with the Master Clock 101. System Controller 102 can include a processing unit, e.g., a central processing unit (CPU) of RISC-based or other types of CPU architectures. System Controller 102 can also include at least one input/output (I/O) unit(s) and/or memory unit(s), which are in communication with the processing unit, to support various functions of the System Controller 102. For example, the processing unit can be associated with a system control bus, e.g., Data & Control Bus 103. System Controller 102 can be implemented as one of various data processing architectures, such as a personal computer (PC), laptop, tablet, and mobile communication device architectures.

The memory unit(s) in the System Controller 102 can store other information and data, such as instructions, software, values, images, and other data processed or referenced by the processing unit. Various types of Random Access Memory (RAM) devices, Read Only Memory (ROM) devices, Flash Memory devices, and other suitable storage media can be used to implement storage functions of the memory unit(s). The memory unit(s) can store pre-store digital DSSS composite waveforms and waveform codes data and information. The memory unit(s) can store data and information obtained from received and processed waveforms, which can be used to generate and transmit new waveforms. The memory unit(s) can be associated with a system control bus, e.g., Data & Control Bus 103.

The I/O unit(s) can be connected to an external interface, source of data storage, and/or display device. The I/O unit(s) can be associated with a control bus of the system 100, e.g., Data & Control Bus 103. The I/O unit(s) can interface with other components of the system 100 using various types of wired or wireless interfaces compatible with typical data communication standards, such as but not limited to Universal Serial Bus (USB), IEEE 1394 (FireWire), Bluetooth, Bluetooth Low Energy (BLE), Zigbee, IEEE 802.11, Wireless Local Area Network (WLAN), Wireless Personal Area Network (WPAN), Wireless Wide Area Network (WWAN), WiMAX, IEEE 802.16 (Worldwide Interoperability for Microwave Access (WiMAX)), 3G/4G/LTE/5G cellular communication methods, Near Field Communication (NFC), and/or parallel interfaces. The I/O unit(s) can interface with an external interface, source of data storage, or display device to retrieve and transfer data and information that can be processed by the processor unit, stored in the memory unit, or exhibited on an output unit.

System Controller 102 can control all of the modules of system 100, e.g., through connection via Data & Control Bus 103. For example, Data & Control Bus 103 can link System Controller 102 to one or more attached digital signal processors, e.g., Digital Signal Processor 104, for processing waveforms for their functional control. Digital Signal Processor 104 can include one or many processors, such as but not limited to ASIC (application-specific integrated circuit), FPGA (field-programmable gate array), DSP (digital signal processor), AsAP (asynchronous array of simple processors), and other types of data processing architectures. Data & Control Bus 103 can also link System Controller 102, as well as Digital Signal Processor 104, to one or more display units with modules for user interfaces, e.g., Display 105 with a module User Interface 106. Display 105 can include many suitable display units, such as but not limited to cathode ray tube (CRT), light emitting diode (LED), and liquid crystal display (LCD) monitor and/or screen as a visual display. Display 105 can also include various types of display, speaker, or printing interfaces. In other examples, Display 105 can include other output apparatuses, such as toner, liquid inkjet, solid ink, dye sublimation, inkless (such as thermal or UV) printing apparatuses and various types of audio signal transducer apparatuses. User Interface 106 can include many suitable interfaces including various types of keyboard, mouse, voice command, touch pad, and brain-machine interface apparatuses.

The system 100 includes Waveform Generator 107, which can be controlled by System Controller 102 for producing one or more digital composite waveforms to be transduced to one or more composite acoustic waveforms that are transmitted by the system 100, e.g., at a target volume of interest. The System Controller 102 is in communication with a DSSS Composite Waveform Input Unit 122, which produces individually coded waveforms for a composite, direct sequence spread spectrum (DSSS)-coded waveform to be transmitted by the system 100 at the target. The DSSS Composite Waveform Input Unit 122 is configured to provide the System Controller 102 with a data set (e.g., digital information) that is communicated to the Waveform Generator 107, which is processed by the Waveform Generator 107 for generation of the one or more digital composite waveforms. The one or more digital waveforms can be generated as analog electronic signals (e.g., analog waveforms) by at least one element in an array of waveform synthesizers and beam controllers, e.g., represented in this example as Waveform Synthesizer and Beam Controller 108. In some embodiments, the Waveform Generator 107 can include at least one of a function generator and/or an arbitrary waveform generator (AWG). For example, Waveform Generator 107 can be configured as an AWG to generate arbitrary digital waveforms for Waveform Synthesizer and Beam Controller 108 to synthesize as individual analog waveforms and/or a composite analog waveform. Waveform Generator 107 can also include at least one memory unit(s) that can store pre-store composite waveform copies (also referred to as “replicas”) produced by the DSSS Composite Waveform Input Unit 122, where the Waveform Generator 107 codes data and information used in the generation of a digital waveform. For example, the replicas of the composite, direct sequence spread spectrum (DSSS), coded waveforms can be stored in the memory of the Waveform Generator 107. In some implementations, the output of the DSSS Composite Waveform Input Unit 122 can be processed locally or remotely and stored for use by the system 100. Whereas, in some implementations, the output of the DSSS Composite Waveform Input Unit 122 can be processed locally or remotely and provided to the Waveform Generator 107 in real-time.

Direct Sequence Spread Spectrum (DSSS) is a signal generation technique that specially encodes an ensemble of individual waveforms comprising unique sets of frequencies and composites them into a composite waveform to be transmitted as an ultrasound beam. The DSSS composite waveform generation technique enables the ultrasound system to identify each composite waveform ultrasound echo associated with each transmitted composite waveform based on the composite waveform structure, where the received ultrasound echo carries unique information about the target volume that allows construction of a high-resolution ultrasound image and the extraction of other data of interest.

The DSSS composite waveform acoustic signal or beam is a composite of two or more unique acoustic signals that includes two or more unique sets of frequencies. In some implementations of the DSSS composite waveform generation technique, the individual coded waveforms that are compiled in the composite waveform are encoded by one or more of the following ways. In one example embodiment, individual coded waveforms are synthesized by sampling one or more portions of a noise signal, which could have varying amplitudes, frequencies and phases in the sampled signal; and processing that noise-based signal to create the DSSS-coded individual waveforms. In another example embodiment, individual coded waveforms are synthesized by generating a digital, pseudo-noise-like signal, which could be a sequence of zero and one integers or real numbers from zero to one; and processing that pseudo-noise-based signal to create the DSSS-coded individual waveforms. Furthermore, in another example embodiment, the individual coded waveforms are synthesized by generating individual waveforms having a single, unique frequency and/or phase than any other generated individual waveform, e.g., where each individual waveform may be of a varying amplitude. For each embodiment, the individual DSSS-coded waveforms are compiled into a composite DSSS coded waveform. In some implementations, for example, a composite DSSS coded waveform can be formed from any of the example DSSS-coded waveform synthesis techniques.

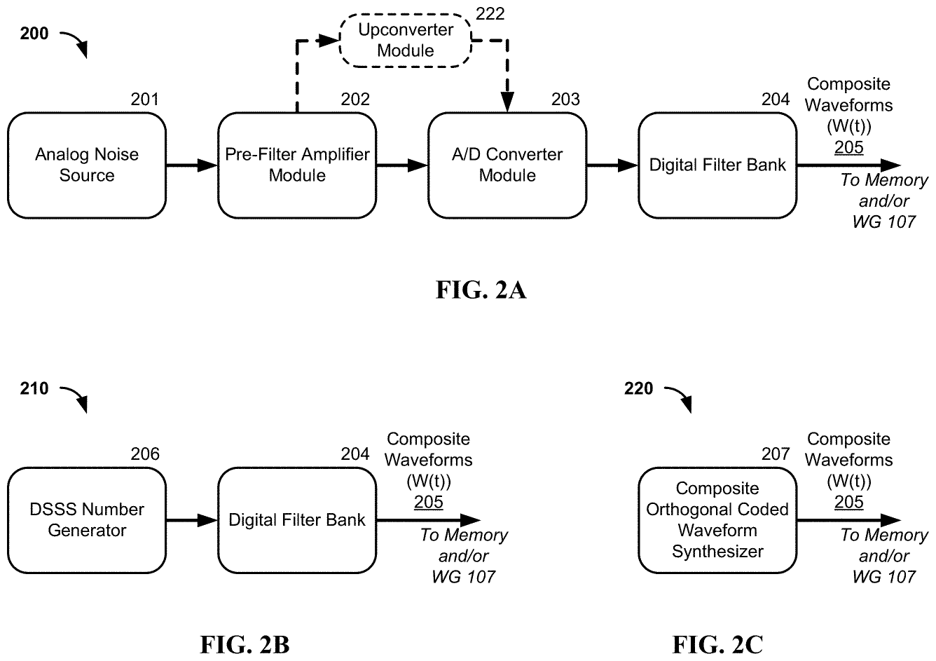

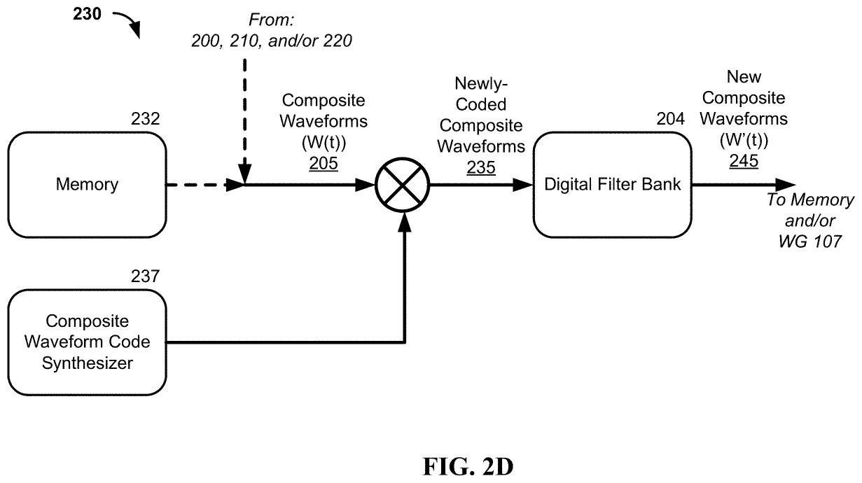

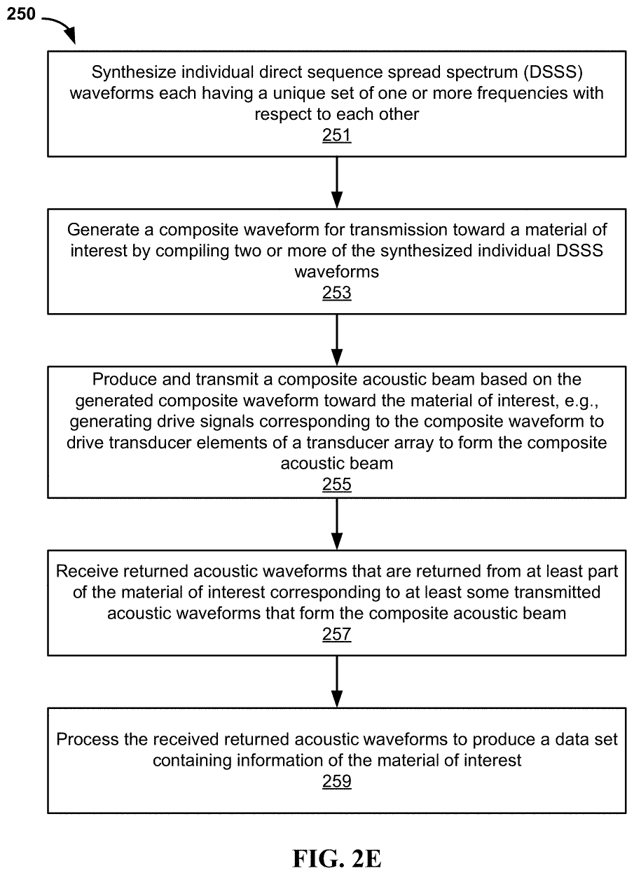

Furthermore, in some embodiments, the individual DSSS coded waveforms can be further coded based on the coding-information source and the manner of unique sets of frequency waveforms into a composite waveform. For example, the coding can add waveform contouring the composite waveform in the frequency domain to overcome transducer limitations, and/or the coding can be used to extract tissue mechanical properties by a post receive processor. Also, for example, the DSSS carrier signal or beam can have its bandwidth increased by a spreading code to form the composite waveform that is to be transmitted. The carrier frequency of a DSSS-coded signal or beam is the center frequency of any resultant composite waveform that is produced by any one of many signal generation techniques, such as those in FIGS. 2A-2D. The spreading code can produce a composite waveform, whose bandwidth magnitude approaches or even exceeds the magnitude of the carrier frequency and can result in a composite waveform that has a time continuous, white noise-like or pink noise-like signal characteristic, e.g., contoured in the frequency domain. The composite DSSS coded waveform may be synthesized by many alternative methods in accordance with the present technology, some of which are discussed below in FIGS. 2A-2D.

Referring back to FIG. 1A, the system 100 includes Waveform Synthesizer and Beam Controller 108 comprising I number of array elements. In one example, Waveform Synthesizer and Beam Controller 108 can be configured to include at least one waveform synthesizer element on each line of the I number of array waveform synthesizers. In another example, Waveform Synthesizer and Beam Controller 108 can include at least one beam controller element on each line of the I number of array beam controllers. In another example, Waveform Synthesizer and Beam Controller 108 can include at least one waveform synthesizer element and beam controller element on each line of the I number of array waveform synthesizers and beam controllers.

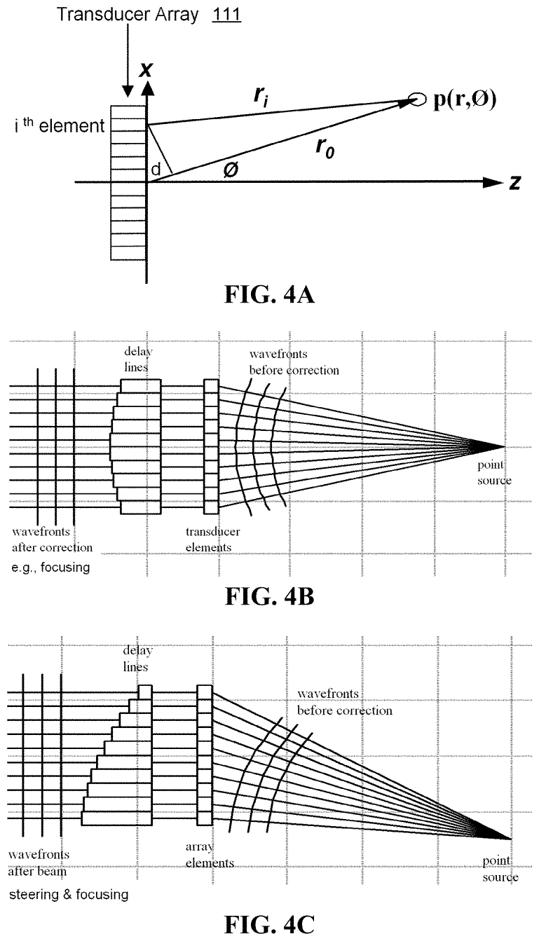

In some embodiments, for example, the Waveform Synthesizer and Beam Controller 108 can include a phase-lock loop system for generation of an electronic signal, e.g., a radio frequency (RF) waveform. An exemplary composite RF waveform can be synthesized by Waveform Synthesizer and Beam Controller 108 from the composite replica stored in memory, e.g., one individual RF waveform can be generated in one array element substantially the same as all other individual waveforms generated by the other array elements of Waveform Synthesizer and Beam Controller 108, e.g., which can be generated with the appropriate delay and amplitude for each as shown later in FIG. 4. In such implementations, for example, Waveform Generator 107 can issue commands and send waveform data including information about each element's individual waveform's properties to Waveform Synthesizer and Beam Controller 108 for generation of a composite RF waveform.

FIGS. 2A, 2B, 2C, and 2D show diagrams depicting four examples of composite waveform synthesizers 200, 210, 220, and 230 for producing composite, direct sequence spread spectrum (DSSS), coded waveforms, W(t) respectively. The example composite waveform synthesizers 200-230 represent different embodiments of the DSSS Composite Waveform Input Unit 122 shown in FIG. 1A, which can be physically integrated with the ultrasound system 100 or can be located remotely. For example, in various implementations, the DSSS composite waveforms produced by the example composite waveform synthesizers 200, 210, 220, and/or 230 can be provided as pre-processed data to the ultrasound system 100.

As shown in FIG. 2A, the DSSS Composite Waveform Synthesizer 200 can use an Analog Noise Source 201 that can include one of many different types of analog noise source devices, such as, for example, hot-cathode diode vacuum tubes, hot-cathode gas-discharge tubes, biased semiconductor diodes, biased avalanche diodes, biased Zener diodes, etc. The analog noise signal from the Analog Noise Source 201 can be buffered, amplified and/or band-pass filtered by a Pre-Filter Amplifier Module 202 of the Composite Waveform Synthesizer 200. The DSSS Composite Waveform Synthesizer 200 includes an Analog-Digital (A/D) Converter Module 203 to digitize the buffered, amplified, and/or band-pass filtered output of the Pre-Filter Amplifier Module 202. In some implementations, for example, if the center frequency of the selected Analog Noise Source 201 is not high enough for the intended application of the ultrasound system 100, it can be upconverted to a higher frequency after buffering and/or amplification is performed at the Pre-Filter Amplifier Module 202 and before the A/D Converter Module 203, e.g., by modulating an analog carrier frequency source of a desired center or carrier frequency. For such implementations, the DSSS Composite Waveform Synthesizer 200 can include an optional Upconverter Module 222 to convert the frequency of the buffered, amplified, and/or band-pass filtered output to a higher frequency analog signal, which is then digitized by the A/D Converter Module 203. The digitized output of the A/D Converter Module 203 can be frequency-coded, phase-coded and/or amplitude-coded by a Digital Post-Filter Bank 204 of the DSSS Composite Waveform Synthesizer 200. The Composite Waveform Synthesizer 200 produces a digital DSSS Composite Waveform (W(t)) output 205, which can be stored for later use by the ultrasound system 100, or it can be used directly by the Waveform Generator 107, or both.

As shown in FIG. 2B, the DSSS Composite Waveform Synthesizer 210 can produce composite waveform 205 by generating direct sequence spread spectrum waveforms, at a DSSS Number Generator 206, using any one of many known random number sequence generation algorithms, such as for example Linear Congruential Generator (LCG), Linear Feedback Shift Register (LFSR), Subtract-With-Borrow (SWC), etc., or deterministic m-sequence number generation algorithms, such as for example Gold, Kasami, sequence algorithms etc. The DSSS Number Generator Module 206 can generate a digital, pseudo-noise like signal, comprised of a sequence of either zero and one integers or real numbers from zero to one. In some implementations, for example, the random number sequence can be frequency-coded, phase-coded and/or amplitude-coded by the Digital Post-Filter Bank 204. The digital Composite Waveform output (W(t)) 205 by the DSSS Composite Waveform Synthesizer 210 can be stored for later use by the ultrasound system 100, or it can be used directly by the Waveform Generator 107, or both.

As shown in FIG. 2C, the DSSS Composite Waveform Synthesizer 220 includes a composite orthogonal coded waveform synthesizer operable to generate a composite waveform comprising individual coded waveforms, as described by Equation 1 (discussed below). The digital Composite Waveform (W(t)) output 205 by the Composite Waveform Synthesizer 220 can be stored for later use by the ultrasound system 100, or it can be used directly by the Waveform Generator 107, or both. The DSSS Composite Waveform Synthesizer 220 can employ techniques for frequency-coding and/or phase-coding waveforms as described in U.S. Pat. No. 8,939,909 B2, titled “SPREAD SPECTRUM CODED WAVEFORMS IN ULTRASOUND IMAGING,” the entire contents of which are incorporated by reference as part of this disclosure for all purposes.

As shown in FIG. 2D, the Composite Waveform Synthesizer 230 can be used with any DSSS Composite Waveform 205 available in memory 232, e.g., a local memory of the system 100 or a global memory accessible to the ultrasound system 100, such as the DSSS Composite Waveform 205 produced by the DSSS Composite Waveform Synthesizer 200 (shown in FIG. 2A), the DSSS Composite Waveform Synthesizer 210 (shown in FIG. 2B), and/or the DSSS Composite Waveform Synthesizer 220 (shown in FIG. 2C). For example, in some embodiments, the Composite Waveform Synthesizer 230 is coupled to the output of one or more of the DSSS Composite Waveform Synthesizer 200 (shown in FIG. 2A), the DSSS Composite Waveform Synthesizer 210 (shown in FIG. 2B), and/or the DSSS Composite Waveform Synthesizer 220 (shown in FIG. 2C). In some implementations of the Composite Waveform 205, the Composite Waveform Code Synthesizer 237 generates a series of orthogonal or quasi-orthogonal code words, e.g., such as Barker codes, Costas codes, Golay codes, Walsh codes, Hadamard codes, Gold codes, etc. The original DSSS Composite Waveform 205 is digitally multiplied by each code word generated by the Composite Waveform Code Synthesizer 207 to produce a newly-coded Composite Waveform 235 that is orthogonal from the original Composite Waveform 205 and from other Composite Waveforms produced by this process. In some implementations, for example, newly-coded Composite Waveform 235 can be frequency-coded, phase-coded and/or amplitude-coded by the Digital Post-Filter Bank 204 to produce new Composite Waveforms (W′(t)) 245. The digital New Composite Waveform (W′(t)) outputs (e.g., New Composite Waveforms 245) by the Composite Waveform Synthesizer 230 can be stored as a replica for later use by the ultrasound system 100, or it can be used directly by the Waveform Generator 107, or both.

FIG. 2E shows a block diagram depicting an example embodiment of a method for acoustic imaging, labeled 250, using the DSSS composite waveform generation technique in accordance with the present technology. The method 250 includes a process 251 to synthesize individual DSSS waveforms each having a unique set of one or more frequencies with respect to each other. The method 250 includes a process 253 to generate a composite waveform for transmission toward a material of interest by compiling two or more of the synthesized individual DSSS waveforms. Implementations of the process 251 and 253 can include implementing any one or combination of the examples of composite waveform synthesizers 200, 210, 220, and 230 for producing composite DSSS coded waveforms as described in FIGS. 2A, 2B, 2C, and 2D, respectively. The method 250 includes a process 255 to produce and transmit a composite acoustic beam based on the generated composite waveform toward the material of interest, which can include generating drive signals corresponding to the composite waveform to drive transducer elements of a transducer array to form the composite acoustic beam. The method 250 includes a process 257 to receive returned acoustic waveforms that are returned from at least part of the material of interest corresponding to at least some transmitted acoustic waveforms that form the composite acoustic beam. The method includes a process 259 to process the received returned acoustic waveforms to produce a data set containing information of the material of interest. The method 250 can be implemented by the system 100 shown in FIG. 1A.

Referring back to FIG. 1A, the individual RF waveforms and/or the composite RF waveform generated by Waveform Synthesizer and Beam Controller 108 can be modified by Output Amplifiers 109, which includes an array of I number of amplifiers, e.g., by amplifying the gain of a waveform. Output Amplifiers 109 can be used as transducer drivers. The composite RF waveform can be passed to Transmit/Receive (T/R) switch 110, e.g., an N-pole double-throw transmit/receive switch. T/R Switch 110 that can be interfaced with a transducer module. A generated composite RF waveform that is to be transmitted into a target medium can be transduced into, for example, an acoustic wave by the transducer module that can include an array of transducer elements, e.g., Transducer Array 111 comprising I number of elements. For example, the transduced acoustic wave can be emitted in the form of an acoustic waveform pulse. Each array element of the Transducer Array 111 may generate one or more acoustic waveforms that correspond to the individual waveform chips determined by the Waveform Generator 107.

The exemplary transduced transmitted acoustic waveform can be transmitted toward a target area, e.g., biological tissue, and form a spatially combined acoustic waveform. The transmitted waveform can propagate into the target medium, which for example, can have one or more inhomogeneous mediums that partially transmit and partially reflect the transmitted acoustic waveform. Exemplary acoustic waveforms that are partially reflected, also referred to as returned acoustic waveforms, can be received by Transducer Array 111. For example, each array element of I array elements of Transducer Array 111 can be configured to receive a returned acoustic waveform convert it to an analog RF waveform. The individual received (analog) RF waveforms can be modified by Pre-Amplifier module 112, which includes an array of I number of amplifiers, e.g., by amplifying the gain of a waveform. The individual received waveforms can be converted from analog format to digital format by analog to digital (A/D) Converter module 113, which includes an array of I number of A/D converters. A/D Converter module 113 can include A/D converters that have low least significant bit (LSB) jitter, spurious-free dynamic range (SFDR) and waveform dependency, such that the exemplary waveforms can be adequately decoded. The converted digital representations of the individual received composite waveforms can be processed by a processor, e.g., Digital Signal Processor 104, in manner that creates and forms a representative image of the target medium.

The exemplary system 100 can be operated in one of many operation modes. In one example, Master Clock 101 can provide the time base for synchronizing the system 100, e.g., as a time base for the Waveform Synthesizers 108. Master Clock 101 can be configured as a low phase noise clock such that the exemplary waveforms can be phase encoded. An operator can select the mode of operation at User Interface 106. Exemplary modes of operation provided for the user to select at the User Interface 106 include Conventional A-Mode (e.g., 1D Depth only image), Conventional B-Mode (e.g., 2D Plane image—transverse vs. depth), Conventional C-Mode (e.g., 2D Plane image at selected depth), and Conventional D-Modes (e.g., Doppler Modes). Exemplary Doppler modes include Color Doppler (e.g. superposition of color coded Doppler and B-mode images), Continuous Doppler (e.g., 1D Doppler profile vs. depth), Pulsed Wave Doppler (e.g., Doppler vs. time for selected volume), and Duplex/Triplex Doppler (e.g., superposition of Conventional B-Mode, Conventional C-Mode or Color Doppler, and Pulsed Wave Doppler). Some other exemplary modes of operations can include Conventional 3D and 4D (“real time” 3D) volume renderings of the previously described modes of operations. The exemplary system 100 can implement new modes of operation that can generate spread spectrum, wide instantaneous bandwidth, frequency- and/or phase-coded waveforms. For example, a user can select exemplary ATS-Modes (Artificial Tissue Staining Modes) that can comprise a B-Mode, a C-Mode, a D-Mode, or other mode combined with image color coding to aid tissue differentiation—analogous to tissue staining for microscopic histological studies; and exemplary CAD-Modes (Computer Aided Diagnostic Modes) that differentiate and identify tissue type. ATS-Modes can employ the use of features for image color coding in image processing based on one or more of a number of measured properties that are obtained from the returned echo waveform from the target area, e.g., the returned echo from an exemplary transmitted spread spectrum, wide instantaneous bandwidth, coded acoustic waveform. CAD-Modes can use classifiers (algorithms) to classify, for example, tissue types based on features of the measured properties of the returned echo from the target area, e.g., the returned echo from an exemplary spread spectrum, wide instantaneous bandwidth, coded acoustic waveforms. The features properties can include differing impedances, amplitude reflections (as a function of wavelength), group delay, etc. Some exemplary classifiers that can be employed using CAD-Modes can include deterministic classifiers, stochastic classifiers (e.g., Bayesian classifiers), and neural network classifiers.

FIG. 1B shows an exemplary operation process 150 for operating system 100. For each time epoch, process 150 can begin by implementing a process 151 to switch system 100 in transmit mode. For example, the System Controller 102 can command an N-pole double-throw T/R switch, e.g., T/R Switch 110, to transmit position. Process 150 can include an exemplary process 152 that checks a user-defined mode of operation. For example, mode of operation can be selected by a user using User Interface 106, or the mode of operation can be selected by another entity or internally within system 100. Based on the selected operation mode, the processes 153 and 154 can be implemented to initiate the System Controller 102 to command Waveform Generator 107 and the DSSS Composite Waveform Input Unit 122 to produce and issue a digital message (data) comprising the waveform information to one or more elements in Waveform Synthesizers and Beam Controllers 108 that defines the amplitude and phase of each of the individual replicas of DSSS coded waveforms that comprise a desired wideband DSSS coded composite RF waveform commanded. Process 152 can occur anywhere and implemented in multiple instances during process 150. Process 150 can include an exemplary process 153 to issue waveform data (e.g., the exemplary digital message/data) to waveform synthesizers and beam formers, such as the Waveform Synthesizers and Beam Controllers 108. Process 150 can include an exemplary process 154 to generate individual analog RF waveforms that correspond to defined DSSS coded waveforms from the replicas. For example, each element in the array of Waveform Synthesizers and Beam Controllers 108 can convert the digital message/data from the Waveform Generator 107 into individual analog waveforms that can make up a coherent analog wideband composite waveform. In some implementations, the process 150 can include an exemplary process 155 to amplify the individual analog waveforms that can make up a coherent analog wideband composite waveform. For example, each analog waveform and/or wideband composite waveform can be amplified by an array element in Output Amplifier 109. The amplified analog wideband composite waveform can then pass through the T/R Switch 110 and excite its respective array element of the Transducer Array 111 (e.g., in an ultrasound probe). Process 150 can include an exemplary process 156 to transduce the composite analog waveform to an acoustic waveform that can propagate throughout the scanned volume. For example, each element of the Transducer Array 111 can provide an acoustic waveform from each of the individual analog waveform corresponding to the frequency chip generated in Waveform Synthesizer and Beam Controller 108 that makes up the wideband composite acoustic waveform. Transducer Array 111 can form the acoustic beam that propagates into the target medium, e.g., biological tissue volume under study.

At the end of process 156, process 150 can implement process 157 to switch system 100 in receive mode. For example, the System Controller 102 can command the N-pole double-throw T/R Switch 110 to receive position. Process 150 can include an exemplary process 158 to receive a returned acoustic waveform, which can be in the form of one or more returned acoustic waveforms (also referred to as acoustic waveform echoes). Process 158 can also include transducing the returned acoustic waveform echo(es) into individual received analog waveforms, e.g., corresponding to the frequency chips of the generated individual waveforms. For example, the returned acoustic waveform propagates back to and is received by Transducer Array 111. Each element of Transducer Array 111 can convert the received acoustic waveform it receives into an analog signal (waveform). Process 150 can include an exemplary process 159 to amplify the individual received analog waveforms. For example, each received analog waveform can be amplified by its respective low noise pre-amplifier element in Pre-Amplifier module 112. Process 150 can include an exemplary process 160 to convert the individual received analog waveforms into digital waveform data. For example, each received (and amplified) analog waveform signal can be converted into a digital word by each respective A/D element in A/D Converter module 113. The digital format data can be sent to Digital Signal Processor 104 for signal processing. Process 150 can include an exemplary process 161 to process the digital waveform data into image frames representative of the target medium. Process 161 can also include compositing the digital waveform data into a composite digital signal representing the individual and composite received analog waveform. For example, Digital Signal Processor 104 can detect the amplitude and phase of each of the frequency chips that comprise the wideband composite acoustic waveform received by each of the transducer array elements. Digital Signal Processor 104 can form the received beam and separate the amplitude and Doppler components of each resolution element of the beam, and can form an image frame associated with mode previously selected by operator. The image frame formed by Digital Signal Processor 104 can be displayed on Display 105 to the user. For other subsequent time epochs, System Controller 102 can repeat this exemplary process, e.g., by commanding Waveform Generator 107 to issue to each element in Waveform Synthesizers 108 another digital message that defines the amplitude and phase of each of the frequency chips that comprise the wideband composite waveform and by commanding T/R Switch 110 back to transmit position, etc.

The disclosed systems and methods can employ the use of spread-spectrum, wide instantaneous bandwidth (up to 100% or more fractional bandwidth), coherent pseudo-random noise, frequency- and phase-coded waveforms. There are limitless embodiments of such waveforms.

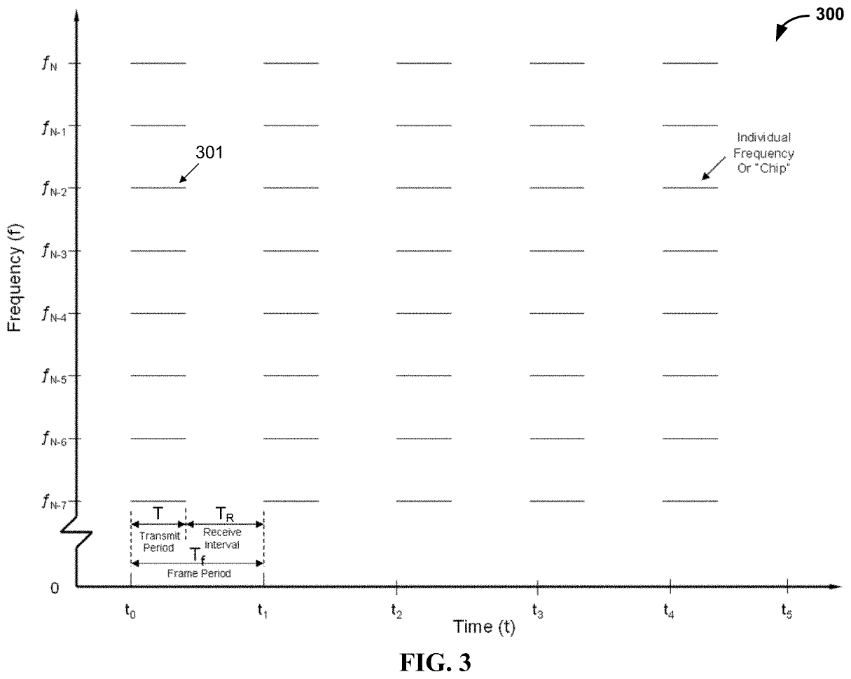

FIG. 3 shows a diagram depicting an example of a composite coded waveform, which shows a plot of a generated composite waveform 300 that is comprised of a plurality of individual coded waveforms. An exemplary tone 301 corresponds to a frequency chip f_{N-2} that is transmitted during a transmit period T beginning at time epoch to.

Exemplary waveform 300 can be represented by an equation for waveform, W, which can be represented in the time domain as a complex number, given by Equation (1):

$$W ( t ) = {\sum }_{k} {\sum }_{n} {A}_{n} {e}^{j ( 2 π {nf}_{0} t + {Φ}_{n k} + {C}_{n} )} U ( t - k {T}_{f} ) \qquad ( 1 )$$

W is comprised of M individual orthogonal frequency-coded waveforms, also referred to as “chips” or “tones”, where j=\sqrt{−1}. T is the chip duration or period, and the fundamental chip frequency f₀=1/NT. n is a sequence of positive integers from N−M+1 to N. The waveform repetition frequency is 1/T_{f}, with T_{f} being the duration of a frame or epoch, and U(x)=1 for 0≤x≤T_{f}. Φₙₖ is the randomly scrambled starting phase of the n^{th} chip in the k^{th} time epoch, and Aₙ is the amplitude of the n^{th} chip. The chip phase, Φₙₖ, is a random number in the set {Iₙₖ2π/N}, where Ink is a sequence of random, positive integers selected without replacement from the series I=0, 1, 2, 3, . . . , N, with N being a large number. Cₙ is a number between 0 and 2π. Chip phase values can be pre-stored in an exemplary database within a memory unit of System Controller 102 and/or Waveform Generator 107. One exemplary variation of the waveform, W, can be to randomly scramble the phase of the n^{th} chip in the k^{th} time epoch Φₙₖ a number of times during chip duration, T, in addition to only scrambling the starting phase.

An exemplary transmitted composite waveform, W, can be comprised of the set of M individual tones that are orthogonal and completely span the frequency range f_{N-M+1} to f_{N}, as seen in FIG. 3. The parameter N can be chosen to be a large number to give W a wide instantaneous bandwidth. In the special case when the lowest frequency f_{N-M+1}=1/T, then W can describe any wideband waveform that may be contained within this range of frequencies. For any tone among the M individual tones, one or more phases (e.g., Φₙₖ) can be encoded in a single tone during the interval T. For example, tone 301 in the first time epoch (t₀) can include a first phase, Φ₂, for example, as its phase shift for the beginning portion of the transmit period T and a second phase Φ₈, for example, as its phase shift for the latter portion of the transmit period T, etc. Additionally, any tone among the M individual tones can include multiple amplitudes encoded in a single tone. This can be implemented by amplitude weighting and phase weighting.

The parameter Aₙ, which is the amplitude of the n^{th} chip, and Cₙ, which is an additive phase term, in combination can provide pre-emphasis of the analog signal that excites each individual element of Transducer Array 111 to produce a transmitted acoustic waveform that has the desired amplitude and phase characteristics over the frequency range of W. Pre-emphasis of the transmitted waveform can compensate for both the non-constant amplitude and phase response of transducer elements as a function of frequency, and the non-uniform propagation characteristics of intervening tissue layers. For example, the pre-emphasis terms can provide an acoustic waveform that has equal amplitude chips with constant (e.g., flat) amplitude and a known phase versus frequency characteristic. Such constant amplitude versus frequency acoustic waveforms can be referred to as ‘white’ waveforms. Alternatively, if pre-emphasis is not provided, then the transmitted acoustic waveform can replicate the frequency response of the transducer, and such waveforms are referred to as ‘colored’ waveforms. De-emphasis of the received waveform can permit determination of the reflection characteristic of the target medium's volume, e.g., biological tissue volume.

By inspection, single frequency modes (e.g., Conventional A-, B- and C-Mode), due to their monochromatic nature, do not need pre-emphasis. Such single frequency waveforms may require amplitude control, for example, to ensure biologically safe sound intensity limits.

If the phase of each chip is random, the transmitted waveform, W, can have random noise-like characteristics. If the phases (Φₙₖ+Cₙ) of each chip are uniquely determined, repeatable and synchronized to the Master Clock (as shown in FIG. 1A), the transmitted waveform, W, can be classified as pseudo-random noise. Such pseudo-random noise waveforms are coherent permitting implementation of coherent receivers.

Image processing advantages of wide instantaneous bandwidth, pseudo-random noise waveforms can include reduction, with proper waveform selection, and potential elimination of speckle, e.g., speckles/speckle patterns, which are random intensity patterns produced by the mutual interference waveforms, which are commonly associated with conventional medical ultrasound images. This exemplary reduction in speckle can be an analogous comparison of a scene illuminated by wide band, Gaussian noise-like white light, which has no observable speckle to narrow band laser illumination with exhibits strong speckle of the same scene.

Signal processing advantages of coherent, pseudo-random noise, frequency- and phase-coded waveforms can include waveforms having very low time and Doppler sidelobes. For example, an ambiguity function, A(τ,ν), can be a two-dimensional representation that shows the distortion of a received waveform processed by a matched filter receiver due to the effect of Doppler shift (ν) or propagation delay (τ). Specifically, the exemplary ambiguity function A(τ,ν) is defined by Equation (2) and is determined solely by the waveform properties and the receiver characteristics and not by the scenario.

$$A ( τ , υ ) = {\int }_{- ∞}^{+ ∞} {X}_{a} ( t ) {X}_{b}^{*} ( t - τ ) {e}^{j 2 π υ t} \\ where {X}_{k} ( t ) = \frac{1}{\sqrt{T}} {e}^{j [ 2 π {f}_{k} ( t - {t}_{k} ) + {Φ}_{k} ]} , \\ for 0 \leq t \leq T , {X}_{k} ( t ) = 0 otherwise . \qquad ( 2 )$$

For waveforms of the type described by Equation (1), the following equation can be obtained:

$$A ( τ , υ , t , {f}_{n} , {Φ}_{n} , {f}_{m} , {Φ}_{m} , T ) = ( 1 - \frac{\vert τ - ( Δ t )}{T} ) \frac{Sin [ 2 π ( Δ f ) ( T - \vert Δ t \vert ) ]}{[ 2 π ( Δ f ) ( T - \vert Δ t \vert ) ]} {e}^{j 2 π [ Δ f ( T + Δ t ) - {f}_{n} Δ t + υ t + ΔΦ ]} \qquad ( 3 )$$

where Δt=τ−t, Δf=ν−(fₙ−fₘ), and ΔΦ=Φₙ−Φₘ, which can result in the complete ambiguity equation shown in Equation (4):

$$x ( τ , υ ) = \frac{1}{M} {\sum }_{n} {\sum }_{m} A ( τ , υ , t , {f}_{n} , {Φ}_{n} , {f}_{m} , {Φ}_{m} , T ) \qquad ( 4 )$$

where both n and m are a sequence of positive integers from N−M+1 to N.

By inspection, many waveforms (W) are possible depending on the specific random number codes (Iₙₖ) selected. However, the sidelobe performance cannot be guaranteed for every waveform defined, and therefore only those codes which give sufficiently low sidelobes as determined by a numerical search of a set of possible codes can be used.

For example, in medical ultrasound applications, living tissue as a propagation medium is inhomogeneous. Propagation medium inhomogeneity can introduce differential time delays, and living tissue can introduce unwanted motion induced Doppler. Ultrasound transducer arrays also can have undesirable side lobes and grating lobes (e.g., due to physical size limitations) in the off axis portions of ultrasound beam that add unwanted time delay and Doppler returns to the returns of the main lobe. Waveforms that exhibit low ambiguity function sidelobes can significantly improve focusing and target contrast due through the reduction interference from differential time delays, motion induced Doppler, transducer side lobe effects.

Coherent pseudo-random noise, frequency- and phase-coded waveforms can enable higher order cross range focusing techniques to be employed that can improve the lateral resolution of size limited ultrasound transducer arrays, e.g., medical ultrasound transducer arrays.

For example, each biological tissue type and each diseased tissue types may exhibit their own unique ultrasound echo return as a function of frequency and spatial morphology. Using conventional Elastograph-Mode (E-Mode) modalities, it can be difficult to take advantage of such properties to classify tissues, e.g., due to measurement errors such as the inability to accurately characterize the ultrasound wave propagation through overlaying inhomogeneous media. Exemplary waveforms produced by the exemplary system 100, e.g., wide instantaneous bandwidth, DSSS, coherent pseudo-random noise, frequency- and phase-coded waveforms, can enable tissue differentiation by simultaneously determining the propagation delay for each acoustic ray through intervening tissue layers and accurately determining the spatial echo features of the target volume under investigation. Classifiers, one example being Bayesian inference Classifiers among others, can be applied to the feature data obtained from the measured characteristics of the received echo to automatically classify tissue types observed in the target volume providing a Computer Aided Diagnostic-Mode (CAD-Mode).

Unlike conventional E-Modes, which inherently have significantly reduced image quality and rely on individual operator technique, the exemplary waveforms described by Equation (1) can inherently provide improved image quality while simultaneously colorizing the resultant image by tissue type in the ATS and/or CAD-Modes. With this advantage, user technique can be mitigated and the margins of a lesion are discernible thus permitting improved diagnoses.

In addition, Waveform Synthesizers 108 positioned on transmit and Digital Signal Processor 104 positioned on receive (as shown in FIG. 1A), can also perform beam control (e.g., beam steering, dynamic beam focusing, and beam forming) functions.

FIGS. 4A-4C show diagrams illustrating examples of these digital electronic functions by introducing a differential time delay, or equivalently phase shifts by frequency component, and amplitude weighting between each of the elements of the phased array. As can be seen in FIG. 4A, the differential time delay or phase shift can compensate for the differential change in distance (d) each acoustic ray (r₁, r₂, . . . ) travels from i^{th} element to the point of focus (p). An angle (θ) is formed as the point of focus (p) is not along the z-axis direction of direct aim/alignment of the Transducer Array 111 toward a target in the target medium. Additionally, a differential amplitude weight, which is commonly known as apodization, can be applied to each element to control the beam shape and suppress side and grating lobes. Also, for one or more chips in one exemplary waveform, like that featured in FIG. 3, Waveform Generator 107 can pre-encode a phase delay to delay the phase of the one or more chips transmitted at each transducer element in Transducer Array 111. An exemplary result of introducing time delays or differential phase shifts can be seen in FIGS. 4B and 4C. The exemplary phase shift or time delay values for the one or more chips can be communicated to Digital Signal Processor 104 and/or System Controller 102 to incorporate the phase shift or time delay values in the signal processing of the received composite waveform.

For narrow instantaneous bandwidth ultrasound devices, this function can be accomplished by introducing phase shift and amplitude attenuation on the composite analog signal driving each element. However, for the exemplary composite waveforms generated by the Composite Orthogonal Coded Waveform Synthesizer 207, each individual chip of the waveform (Wᵢ) can be individually amplitude weighted (Bₙᵢ) and phase weighted (Dₙᵢ) as a function of frequency (n) for each array element (i) individually for all I elements, as indicated by Equation (5).

$${W}_{i} ( t ) = {\sum }_{k} {\sum }_{n} {A}_{n} {B}_{ni} {e}^{j ( 2 π {nf}_{0} t + {Φ}_{n k} + {C}_{n} + {D}_{ni} )} U ( t - k {T}_{f} ) \qquad ( 5 )$$

On transmit, the amplitude and phase weighting required of each chip can be computed by the System Controller 102 and can be sent as an instruction to the Waveform Generator 107. Waveform Generator 107 can then send the digital words (real and imaginary components) to the Waveform Synthesizers and Beam Controller 108 that produces the analog drive signal that is amplified by Amplifier 109 and sent to each element of the array of Transducer Array 111. Alternatively, for the other Composite Waveforms embodiments, a time delay can be computed by the System Controller 102 and can be sent as an instruction to the Waveform Generator 107. Waveform Generator 107 can then send the digital words (e.g., real and imaginary components) to the Waveform Synthesizers and Beam Controller 108 that produces the analog drive signal that is amplified by Amplifier 109 and sent to each element of the array of Transducer Array 111.

On receive, the reverse process takes place. The A/D Converter module 113 can send the digital words that represent the amplitude and phase information of each chip for each array element or the time delay of the Composite Waveform to the Digital Signal Processor 104, which in turn can digitally form the receive beam for each chip.

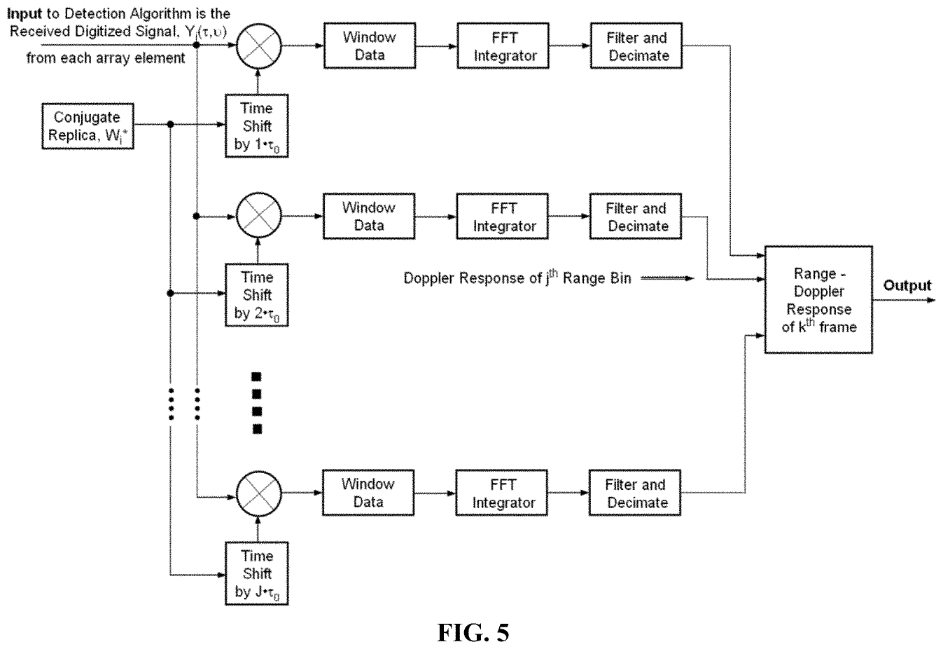

A multitude of ways can be used to process the received composite waveforms, e.g., DSSS coded waveforms. FIG. 5 shows an exemplary correlation processing technique. For example, an input to the exemplary correlation processing technique can include a digitized received signal, Yᵢ(τ,ν), which can be multiplied by the complex conjugate replica of the transmitted digital composite waveform, Wᵢ*(τ). The complex conjugate replica Wᵢ*(τ) can be time shifted by 1·τ₀ prior to multiplication. This multiplication operation can be repeated multiple times for multiple time shifts, e.g., J times, as seen in FIG. 5. The multiple multiplication operations for the multiple time shifts can be repeated in parallel, but for each operation the replica is shifted in time by an increment, τ₀, from the previous one, as shown in the figure. For each time step, the resultant products can be filtered with a window function, such as a Hann, Hamming, Tukey, Kaiser Bessel, Dolph-Chebyshev, Blackman-Harris window, etc., a fast Fourier Transform (FFT) integrator, and passed through a digital filter. For example, a digital filter of a type that is dependent of the specific waveform, W, can be employed to filter and decimate the inputted signal. The exemplary process can result in the range-Doppler return for each individual i^{th} element of the transducer array. The output data stream from the exemplary detection algorithm can then be processed using conventional techniques to form an image for display. The processed range and Doppler waveforms can be further processed by partitioning the I number of transducer elements into two or more subarrays. The processed range-Doppler return for the i^{th} element can be weighted in amplitude and/or phase depending on which subarray that i^{th} element belongs. These weighted returns can then be summed and differenced. These sum and differences can then be processed to improve the cross range image resolution of the system.

Several applications and uses of the disclosed technology can be implemented to exploit the described features of the aforementioned systems, methods, and devices. Some examples are described for clinical use of the disclosed technology.

In one exemplary application, the resultant image quality, the ATS and CAD modes of an exemplary DSSS ultrasound device can enable the primary care physician to incorporate this modality into a routine examination screening protocol to locate early stage malignancies (e.g., Stage 0 or 1), as well as later stage cancers. As the result of this application, the device can potentially, for example, enhance the survival rate of hard to diagnose asymptomatic patients suffering from such malignancies such as stomach, pancreatic, bladder cancers, etc.

In another exemplary application, the resultant image quality, ATS and CAD modes of an exemplary DSSS ultrasound device can permit board certified radiologists to diagnose neoplasms as benign or malignant prior to any surgical biopsy or resection intervention. As a result of this application, the ability of radiologists to locate and diagnose early stage malignancies (e.g., Stage 0 or 1) can potentially improve patient survival rate. Additionally, unnecessary biopsies can potentially be avoided, along with their attendant risk of hard to treat or even lethal complications such as, for example, methicillin resistant Staphylococcus aureus (MRSA staph) infections.

In another exemplary application, the resultant 3D image quality of an exemplary spread spectrum ultrasound device and its 4D imaging capability can be used in fine needle biopsy and other medical procedures. For example, the exemplary spread spectrum ultrasound device can be integrated into an exemplary fine needle biopsy instrument (e.g., with the device's transducer probe), which can permit the fine needle biopsy of very small, early stage (e.g., Stage 0 or 1) neoplasms to confirm noninvasive diagnoses. As a result of this application, the ability of surgeons to avoid open biopsies and the potential for hard to treat and lethal complications that may result is clearly beneficial to the patient.

In another exemplary application, the integration of this device's spread spectrum transducer probe with minimally invasive surgical high definition video instrumentation can permit the fusing of the optical and ultrasound images. Given the improved 3D image quality of this spread spectrum ultrasound device, its 4D imaging capability, the ATS and CAD modes, such fused video and ultrasound images can give surgeons the added ability to locate and surgically excise diseased tissue without excising excessive healthy tissue.

In another exemplary application, given the improved 3D image quality of this spread spectrum ultrasound device, its 4D imaging capability, and its ATS modes, an exemplary spread spectrum ultrasound device can reduce the amount of time for the brachytherapy treatment of malignant neoplasms by precisely guiding the insertion of catheters and sealed radioactive sources into the proper location. The application of this spread spectrum ultrasound device to brachytherapy can be especially useful for the treatment of small, hard to locate neoplasms and their margins.

In another exemplary application, given the improved 3D image quality of this spread spectrum ultrasound device, its 4D imaging capability, and its ATS modes, an exemplary spread spectrum ultrasound device can enable the effective insertion of high dose, localized pharmaceutical treatments of diseases by precisely guiding the insertion of catheters and pharmaceuticals into the proper location. The application of this spread spectrum ultrasound device to brachytherapy can be especially useful for the treatment of small, hard to locate neoplasms.

### Examples

The following examples are illustrative of several embodiments of the present technology. Other exemplary embodiments of the present technology may be presented prior to the following listed examples, or after the following listed examples.

In some embodiments in accordance with the present technology (example A1), a method for acoustic waveform imaging includes generating a wide-band composite waveform to form for transmission toward a material of interest by synthesizing individual direct sequence spread spectrum (DSSS) coded waveforms; transmitting a composite acoustic waveform based on drive signals produced from the individual DSSS coded waveforms of the generated wide-band composite waveform toward the material of interest, wherein the transmitting includes generating the drive signals based the individual DSSS coded waveforms to drive transducer elements of a transducer array to form the composite acoustic waveform; receiving returned acoustic waveforms that are returned from at least part of the material of interest corresponding to at least some transmitted acoustic waveforms that form the composite acoustic waveform; and processing the received returned acoustic waveforms to produce a data set containing information of the material of interest.

Example A2 includes the method of any of the preceding or subsequent examples among A1-A11, wherein the data set includes range-Doppler return data for each returned acoustic waveforms associated with the at least part of the material of interest.

Example A3 includes the method of any of the preceding or subsequent examples among A1-A11, wherein the processing further includes processing the produced data set to generate an image of at least part of the material of interest.

Example A4 includes the method of any of the preceding or subsequent examples among A1-A11, wherein the information of the material of interest includes a physical property of at least a region of the material of interest, wherein the region includes a surface of the material of interest or a portion of the material of interest including a surface and a bulk material beneath the surface.

Example A5 includes the method of any of the preceding or subsequent examples among A1-A11, wherein the processing the received returned acoustic waveforms to produce the data set includes converting the received returned acoustic waveforms from analog signal data into digital signal data, digitizing the composite waveform that corresponds to the transmitted composite acoustic waveform, adding a delay to a complex conjugate replica of each of the individual orthogonal coded waveforms of the digitized composite waveform, wherein each delay is shifted in time by an time increment with respect to another delay corresponding to another individual orthogonal coded waveform, multiplying the digital signal data corresponding to the received returned acoustic waveforms by the delayed complex conjugate replicas of the digitized composite waveform, and filtering the products of the multiplying operation with one or more of a window function, a fast Fourier Transform (FFT), or a digital filter to produce the data set.

Example A6 includes the method of any of the preceding or subsequent examples among A1-A11, wherein the adding the delay and the multiplying operations are conducted for each of the individual orthogonal coded waveforms of the digitized composite waveform in parallel.

Example A7 includes the method of any of the preceding or subsequent examples among A1-A11, wherein the window function includes one or more of a Hann window, Hamming window, Tukey window, Kaiser Bessel window, Dolph-Chebyshev window, or Blackman-Harris window.

Example A8 includes the method of any of the preceding or subsequent examples among A1-A11, wherein the digital filter is operable to reduce the sample rate of inputted signals and produce an output signal having a sampling rate commensurate to a Doppler frequency.

Example A9 includes the method of any of the preceding or subsequent examples among A1-A11, further including selecting a mode of operation of ultrasound imaging including one of (i) ATS-Mode of imaging biological tissue that enables image color coding based on at least one feature of one or more measured properties that are obtained from the returned acoustic waveform, or (ii) CAD-Mode of imaging biological tissue that uses one or more algorithmic classifiers to classify biological tissue types using at least one feature of one or more measured properties that are obtained from the returned acoustic waveform, and processing the data set to produce an image of at least part of the material of interest in accordance with the selected mode of operation.

Example A10 includes the method of any of the preceding or subsequent examples among A1-A11, further including displaying a color-coded image of the biological tissue based on the classified biological tissue types.

Example A11 includes the method of any of the preceding or subsequent examples among A1-A10, wherein the material of interest includes a biological material.

In some embodiments in accordance with the present technology (example A12), an acoustic waveform imaging system includes a waveform generation unit comprising one or more waveform synthesizers coupled to at least one waveform generator, wherein the waveform generation unit synthesizes a composite waveform comprising a plurality of individual direct sequence spread spectrum (DSSS) coded waveforms that are generated by the one or more waveform synthesizers according to waveform information provided by the at least one waveform generator; a transmit/receive switching unit that switches between a transmit mode and a receive mode; an array of transducer elements in communication with the transmit/receive switching unit that transmits an acoustic waveform based on the composite waveform toward a material of interest and receives a returned acoustic waveform returned from at least part of the material of interest; an array of at least one A/D converters that converts the received returned acoustic waveform received by the array of transducer elements from analog format to digital format as a received composite waveform comprising information comprising information of the material of interest; a data processing device including a controller unit in communication with the waveform generation unit and the array of at least one A/D converters, the data processing device comprising a processing unit that includes a processor and memory operable to process the received composite waveform to produce a data set containing information of the material of interest; and a user interface unit in communication with the controller unit.

Example A13 includes the system of any of the preceding or subsequent examples among A12-A25, wherein the data set includes range-Doppler return data for each returned acoustic waveforms associated with the at least part of the material of interest.

Example A14 includes the system of any of the preceding or subsequent examples among A12-A25, wherein the data processing device is operable to process the produced data set to generate an image of at least part of the material of interest.

Example A15 includes the system of any of the preceding or subsequent examples among A12-A25 or proceeding or subsequent claims, wherein the user interface unit comprises a display that displays an image.

Example A16 includes the system of any of the preceding or subsequent examples among A12-A25, wherein the waveform generation unit further comprises one or more amplifiers configured between the transmit/receive switching unit and the one or more waveform synthesizers that modifies the composite waveform.

Example A17 includes the system of any of the preceding or subsequent examples among A12-A25, further comprising an array of one or more pre-amplifiers configured between the transmit/receive switching unit and the array of at least one A/D converters that modifies the received returned acoustic waveform.

Example A1b includes the system of any of the preceding or subsequent examples among A12-A25, wherein the processing unit comprises a digital signal processor (DSP).

Example A19 includes the system of any of the preceding or subsequent examples among A12-A25, wherein the data processing device further comprises a master clock that synchronizes time in at least one of the elements of the acoustic waveform imaging system.

Example A20 includes the system of any of the preceding or subsequent examples among A12-A25, wherein the user interface unit is operable to receive a mode of operation input from a user.

Example A21 includes the system of any of the preceding or subsequent examples among A12-A25, wherein the mode of operation includes at least one of ATS-Mode (Artificial Tissue Staining Mode) for imaging biological tissue that enables image color coding based on at least one feature of one or more measured properties that are obtained from the returned acoustic waveform.

Example A22 includes the system of any of the preceding or subsequent examples among A12-A25, wherein the mode of operation includes at least one of CAD-Mode (Computer Aided Diagnostic Mode) for imaging biological tissue that uses one or more algorithmic classifiers to classify biological tissue types using at least one feature of one or more measured properties that are obtained from the returned acoustic waveform.

Example A23 includes the system of any of the preceding or subsequent examples among A12-A25, wherein the user interface unit comprises a display that displays a color coded image of the biological tissue based on the classified biological tissue types.

Example A24 includes the system of any of the preceding or subsequent examples among A12-A25, wherein the array of transducer elements is partitioned into two or more subarrays to provide enhanced cross-range resolution.

Example A25 includes the system of any of the preceding or subsequent examples among A12-A24, wherein the material of interest includes a biological material.

In some embodiments in accordance with the present technology (example B1), a method for acoustic imaging includes synthesizing individual direct sequence spread spectrum (DSSS) waveforms each having a unique set of one or more frequencies with respect to each other; generating a composite waveform for transmission toward a material of interest by compiling two or more of the synthesized individual DSSS waveforms; producing and transmitting a composite acoustic beam based on the generated composite waveform toward the material of interest, wherein the transmitting includes generating drive signals corresponding to the composite waveform to drive transducer elements of a transducer array to form the composite acoustic beam; receiving returned acoustic waveforms that are returned from at least part of the material of interest corresponding to at least some transmitted acoustic waveforms that form the composite acoustic beam; and processing the received returned acoustic waveforms to produce a data set containing information of the material of interest.

Example B2 includes the method of any of examples B1-B22, wherein the synthesizing comprises generating an analog noise signal from an analog noise source; processing the generated analog noise signal by one or more of buffering, amplifying, or band-pass filtering the analog noise signal; digitizing the processed analog noise signal; and creating a DSSS composite coded waveform from the digitized noise signal based on a frequency-code, a phase-code, and/or an amplitude-code of a waveform having the unique set of one or more frequencies.

Example B3 includes the method of any of examples B1-B22, wherein the synthesizing further comprises upconverting the processed analog noise signal to a higher frequency after buffering and/or amplification by modulating an analog carrier frequency source.

Example B4 includes the method of any of examples B1-B22, wherein the analog noise source includes an output from one or more of a hot-cathode diode vacuum tube, a hot-cathode gas-discharge tube, a biased semiconductor diode, a biased avalanche diode, or a biased Zener diode.

Example B5 includes the method of any of examples B1-B22, wherein the synthesizing comprises generating a digital, pseudo-noise-like signal comprised of a sequence of zero and one integers or real numbers from zero to one; and creating a DSSS composite coded waveform from the generated digital, pseudo-noise-like signal based on a frequency-code, a phase-code, and/or an amplitude-code of a waveform having the unique sets of one or more frequencies.

Example B6 includes the method of any of examples B1-B22, wherein the generating includes determining a random number sequence using at least one of a Linear Congruential Generator (LCG), Linear Feedback Shift Register (LFSR), Subtract-With-Borrow (SWC), or deterministic m-sequence number generation algorithm including one or more of a Gold sequence algorithm or a Kasami sequence algorithm.

Example B7 includes the method of any of examples B1-B22, wherein the synthesizing comprises selecting one or more of a frequency, a phase, or an amplitude to produce a frequency-code, a phase-code, and/or an amplitude-code signal; and creating a DSSS composite coded waveform based on the frequency-code, the phase-code, and/or the amplitude-code signal having the unique sets of one or more frequencies.

Example B8 includes the method of any of examples B2-B7, which can optionally include features in any of examples B8-B22, wherein the synthesizing further comprises generating a series of orthogonal or quasi-orthogonal code words; and digitally multiplying each of the created DSSS composite coded waveforms by at least one of the code words of the generated series of orthogonal or quasi-orthogonal code words to produce a newly-coded composite waveform.

Example B9 includes the method of example B8, which can optionally include features in any of examples B8-B22, wherein the synthesizing further comprises producing a new composite waveform by frequency-coding, phase-coding and/or amplitude-coding the produced newly-coded DSSS composite waveform.

Example B10 includes the method of any of examples B8 or B9, wherein the series of orthogonal or quasi-orthogonal code words include one or more of a Barker code, a Costas code, a Golay code, a Walsh code, a Hadamard code, or a Gold code.

Example B11 includes the method of any of examples B1-B22, further comprising storing the composite waveform in a memory.

Example B12 includes the method of any of examples B1-B22, wherein the processing includes associating each of the received returned acoustic waveforms with a respective individual DSSS coded waveform that formed the composite acoustic beam transmitted at the material of interest.

Example B13 includes the method of any of examples B1-B22, wherein the data set includes range-Doppler return data for each returned acoustic waveforms associated with the at least part of the material of interest.

Example B14 includes the method of any of examples B1-B22, wherein the processing further includes processing the produced data set to generate an image of at least part of the material of interest.

Example B15 includes the method of any of examples B1-B22, wherein the information of the material of interest includes a physical property of at least a region of the material of interest, wherein the region includes a surface of the material of interest or a portion of the material of interest including a surface and a bulk material beneath the surface.

Example B16 includes the method of any of examples B1-B22, wherein the processing the received returned acoustic waveforms to produce the data set includes converting the received returned acoustic waveforms from analog signal data into digital signal data, digitizing the composite waveform that corresponds to the transmitted composite acoustic waveform, adding a delay to a complex conjugate replica of each of the individual orthogonal coded waveforms of the digitized composite waveform, wherein each delay is shifted in time by an time increment with respect to another delay corresponding to another individual orthogonal coded waveform, multiplying the digital signal data corresponding to the received returned acoustic waveforms by the delayed complex conjugate replicas of the digitized composite waveform, and filtering the products of the multiplying operation with one or more of a window function, a fast Fourier Transform (FFT), or a digital filter to produce the data set.

Example B17 includes the method of any of examples B1-B22, wherein the adding the delay and the multiplying operations are conducted for each of the individual orthogonal coded waveforms of the digitized composite waveform in parallel.

Example B18 includes the method of any of examples B1-B22, wherein the window function includes one or more of a Hann window, Hamming window, Tukey window, Kaiser Bessel window, Dolph-Chebyshev window, or Blackman-Harris window.

Example B19 includes the method of any of examples B1-B22, wherein the digital filter is operable to reduce the sample rate of inputted signals and produce an output signal having a sampling rate commensurate to a Doppler frequency.

Example B20 includes the method of any of examples B1-B22, further comprising selecting a mode of operation of ultrasound imaging including one of (i) ATS-Mode of imaging biological tissue that enables image color coding based on at least one feature of one or more measured properties that are obtained from the returned acoustic waveform, or (ii) CAD-Mode of imaging biological tissue that uses one or more algorithmic classifiers to classify biological tissue types using at least one feature of one or more measured properties that are obtained from the returned acoustic waveform, and processing the data set to produce an image of at least part of the material of interest in accordance with the selected mode of operation.

Example B21 includes the method of any of examples B1-B22, further comprising displaying a color-coded image of the biological tissue based on the classified biological tissue types.

Example B22 includes the method of any of examples B1-B21, wherein the material of interest includes a biological material.

In some embodiments in accordance with the present technology (example B23), an acoustic imaging system includes a direct sequence spread spectrum (DSSS) waveform generator to generate a composite waveform comprising two or more individual DSSS waveforms, where each individual DSSS waveform includes a unique set of one or more frequencies with respect to each other; a waveform generation unit coupled to DSSS waveform generator, wherein the waveform generation unit produces and controls transmission of a composite acoustic beam based on the generated composite waveform toward a material of interest; an array of transducer elements in communication with the waveform generation unit to transmit the composite acoustic beam toward the material of interest and to receive returned acoustic waveforms returned from at least part of the material of interest, wherein the waveform generation unit is operable to control the transmission of the composite acoustic beam by generating drive signals corresponding to the composite waveform to drive transducer elements of the transducer array to form the composite acoustic beam; an array of at least one A/D converters that converts the received returned acoustic waveform received by the array of transducer elements from analog format to digital format as a received composite waveform comprising information comprising information of the material of interest; a data processing device including a controller unit in communication with the waveform generation unit and the array of at least one A/D converters, the data processing device comprising a processing unit that includes a processor and memory operable to process the received composite waveform to produce a data set containing information of the material of interest; and (optionally) a user interface unit in communication with the controller unit.

Example B24 includes the system of any of examples B23-B40, wherein the DSSS waveform generator is configured to generate the composite waveform by generating an analog noise signal from an analog noise source; processing the generated analog noise signal by one or more of buffering, amplifying, or band-pass filtering the analog noise signal; digitizing the processed analog noise signal; and creating a DSSS composite coded waveform from the digitized noise signal based on a frequency-code, a phase-code, and/or an amplitude-code of a waveform having the unique set of one or more frequencies.

Example B25 includes the system of any of examples B23-B40, wherein the DSSS waveform generator is configured to generate the composite waveform by generating a digital, pseudo-noise-like signal comprised of a sequence of zero and one integers or real numbers from zero to one; and creating a DSSS composite coded waveform from the generated digital, pseudo-noise-like signal based on a frequency-code, a phase-code, and/or an amplitude-code of a waveform having the unique sets of one or more frequencies.

Example B26 includes the system of any of examples B23-B40, wherein the DSSS waveform generator is configured to generate the composite waveform by selecting one or more of a frequency, a phase, or an amplitude to produce a frequency-code, a phase-code, and/or an amplitude-code signal; and creating a DSSS composite coded waveform based on the frequency-code, the phase-code, and/or the amplitude-code signal having the unique sets of one or more frequencies.

Example B27 includes the system of any of examples B24-B26, which may include features from the system in any of examples B28-B40, wherein the DSSS waveform generator is configured to generate the composite waveform by generating a series of orthogonal or quasi-orthogonal code words; and digitally multiplying each of the created DSSS composite coded waveforms by at least one of the code words of the generated series of orthogonal or quasi-orthogonal code words to produce a newly-coded composite waveform.

Example B28 includes the system of any of examples B23-B40, wherein the DSSS waveform generator is configured to a new composite waveform by frequency-coding, phase-coding and/or amplitude-coding the produced newly-coded DSSS composite waveform.

Example B29 includes the system of any of examples B23-B40, wherein the data set includes range-Doppler return data for each returned acoustic waveforms associated with the at least part of the material of interest.

Example B30 includes the system of any of examples B23-B40, wherein the data processing device is operable to process the produced data set to generate an image of at least part of the material of interest.

Example B31 includes the system of any of examples B23-B40, wherein the user interface unit comprises a display that displays an image.

Example B32 includes the system of any of examples B23-B40, wherein the waveform generation unit further comprises one or more amplifiers configured between a transmit/receive switching unit that is coupled to the array of transducers and the one or more waveform synthesizers that modifies the composite waveform.

Example B33 includes the system of any of examples B23-B40, further comprising an array of one or more pre-amplifiers configured between a transmit/receive switching unit that is coupled to the array of transducers and the array of at least one A/D converters that modifies the received returned acoustic waveform.

Example B34 includes the system of any of examples B23-B40, wherein the data processing device further comprises a master clock that synchronizes time in at least one of the elements of the acoustic waveform imaging system.

Example B35 includes the system of any of examples B23-B40, wherein the user interface unit is operable to receive a mode of operation input from a user.

Example B36 includes the system of any of examples B23-B40, wherein the mode of operation includes at least one of ATS-Mode (Artificial Tissue Staining Mode) for imaging biological tissue that enables image color coding based on at least one feature of one or more measured properties that are obtained from the returned acoustic waveform.

Example B37 includes the system of any of examples B23-B40, wherein the mode of operation includes at least one of CAD-Mode (Computer Aided Diagnostic Mode) for imaging biological tissue that uses one or more algorithmic classifiers to classify biological tissue types using at least one feature of one or more measured properties that are obtained from the returned acoustic waveform.

Example B38 includes the system of any of examples B23-B40, wherein the user interface unit comprises a display that displays a color coded image of the biological tissue based on the classified biological tissue types.

Example B39 includes the system of any of examples B23-B40, wherein the array of transducer elements is partitioned into two or more subarrays to provide enhanced cross-range resolution.

Example B40 includes the system of any of examples B23-B40, wherein the material of interest includes a biological material.

Implementations of the subject matter and the functional operations described in this specification, such as various modules, can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, such as, for example, digital signal processors (DSP), and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Only a few implementations and examples are described and other implementations, enhancements and variations can be made based on what is described and illustrated in this patent document.

What is claimed is:

1. A method for acoustic imaging, comprising:
synthesizing individual direct sequence spread spectrum (DSSS) waveforms each having a unique set of one or more frequencies with respect to each other;
generating a composite waveform for transmission toward a material of interest by compiling two or more of the synthesized individual DSSS waveforms;
producing and transmitting a composite acoustic beam based on the generated composite waveform toward the material of interest, wherein the transmitting includes generating drive signals corresponding to the composite waveform to drive transducer elements of a transducer array to form the composite acoustic beam;
receiving returned acoustic waveforms that are returned from at least part of the material of interest corresponding to at least some transmitted acoustic waveforms that form the composite acoustic beam; and
processing the received returned acoustic waveforms to produce a data set containing information of the material of interest.

2. The method of claim 1, wherein the synthesizing comprises:
generating an analog noise signal from an analog noise source;
processing the generated analog noise signal by one or more of buffering, amplifying, or band-pass filtering the analog noise signal;
digitizing the processed analog noise signal; and
creating a DSSS composite coded waveform from the digitized noise signal based on a frequency-code, a phase-code, and/or an amplitude-code of a waveform having the unique set of one or more frequencies.

3. The method of claim 2, wherein the synthesizing further comprises:
upconverting the processed analog noise signal to a higher frequency after buffering and/or amplification by modulating an analog carrier frequency source.

4. The method of claim 2, wherein the analog noise source includes an output from one or more of a hot-cathode diode vacuum tube, a hot-cathode gas-discharge tube, a biased semiconductor diode, a biased avalanche diode, or a biased Zener diode.

5. The method of claim 1, wherein the synthesizing comprises:
generating a digital, pseudo-noise-like signal comprised of a sequence of zero and one integers or real numbers from zero to one; and
creating a DSSS composite coded waveform from the generated digital, pseudo-noise-like signal based on a frequency-code, a phase-code, and/or an amplitude-code of a waveform having the unique sets of one or more frequencies.

6. The method of claim 5, wherein the generating includes determining a random number sequence using at least one of a Linear Congruential Generator (LCG), Linear Feedback Shift Register (LFSR), Subtract-With-Borrow (SWC), or deterministic m-sequence number generation algorithm including one or more of a Gold sequence algorithm or a Kasami sequence algorithm.

7. The method of claim 1, wherein the synthesizing comprises:
selecting one or more of a frequency, a phase, or an amplitude to produce a frequency-code, a phase-code, and/or an amplitude-code signal; and
creating a DSSS composite coded waveform based on the frequency-code, the phase-code, and/or the amplitude-code signal having the unique sets of one or more frequencies.

8. The method of claim 1, wherein the synthesizing further comprises:
generating a series of orthogonal or quasi-orthogonal code words; and
digitally multiplying each of a created DSSS composite coded waveform by at least one of the code words of the generated series of orthogonal or quasi-orthogonal code words to produce a newly-coded composite waveform.

9. The method of claim 8, wherein the synthesizing further comprises:
producing a new composite waveform by frequency-coding, phase-coding and/or amplitude-coding the produced newly-coded DSSS composite waveform.

10. The method of claim 8, wherein the series of orthogonal or quasi-orthogonal code words include one or more of a Barker code, a Costas code, a Golay code, a Walsh code, a Hadamard code, or a Gold code.

11. The method of claim 1, further comprising:
storing the composite waveform in a memory.

12. The method of claim 1, wherein the processing includes associating each of the received returned acoustic waveforms with a respective individual DSSS coded waveform that formed the composite acoustic beam transmitted at the material of interest.

13. The method of claim 1, wherein the data set includes range-Doppler return data for each returned acoustic waveforms associated with the at least part of the material of interest.

14. The method of claim 1, wherein the processing further includes:
processing the produced data set to generate an image of at least part of the material of interest.

15. The method of claim 1, wherein the information of the material of interest includes a physical property of at least a region of the material of interest, wherein the region includes a surface of the material of interest or a portion of the material of interest including a surface and a bulk material beneath the surface.

16. An acoustic imaging system, comprising:
a direct sequence spread spectrum (DSSS) waveform generator to generate a composite waveform comprising two or more individual DSSS waveforms, where each individual DSSS waveform includes a unique set of one or more frequencies with respect to each other;
a waveform generation unit coupled to DSSS waveform generator, wherein the waveform generation unit produces and controls transmission of a composite acoustic beam based on the generated composite waveform toward a material of interest;
an array of transducer elements in communication with the waveform generation unit to transmit the composite acoustic beam toward the material of interest and to receive returned acoustic waveforms returned from at least part of the material of interest, wherein the waveform generation unit is operable to control the transmission of the composite acoustic beam by generating drive signals corresponding to the composite waveform to drive transducer elements of the transducer array to form the composite acoustic beam;
an array of at least one A/D converters that converts the received returned acoustic waveform received by the array of transducer elements from analog format to digital format as a received composite waveform comprising information comprising information of the material of interest;
a data processing device including a controller unit in communication with the waveform generation unit and the array of at least one A/D converters, the data processing device comprising a processing unit that includes a processor and memory operable to process the received composite waveform to produce a data set containing information of the material of interest; and
a user interface unit in communication with the controller unit.

17. The system of claim 16, wherein the DSSS waveform generator is configured to generate the composite waveform by generating an analog noise signal from an analog noise source; processing the generated analog noise signal by one or more of buffering, amplifying, or band-pass filtering the analog noise signal; digitizing the processed analog noise signal; and creating a DSSS composite coded waveform from the digitized noise signal based on a frequency-code, a phase-code, and/or an amplitude-code of a waveform having the unique set of one or more frequencies.

18. The system of claim 16, wherein the DSSS waveform generator is configured to generate the composite waveform by generating a digital, pseudo-noise-like signal comprised of a sequence of zero and one integers or real numbers from zero to one; and creating a DSSS composite coded waveform from the generated digital, pseudo-noise-like signal based on a frequency-code, a phase-code, and/or an amplitude-code of a waveform having the unique sets of one or more frequencies.

19. The system of claim 16, wherein the DSSS waveform generator is configured to generate the composite waveform by selecting one or more of a frequency, a phase, or an amplitude to produce a frequency-code, a phase-code, and/or an amplitude-code signal; and creating a DSSS composite coded waveform based on the frequency-code, the phase-code, and/or the amplitude-code signal having the unique sets of one or more frequencies.

20. The system of claim 16, wherein the DSSS waveform generator is configured to generate the composite waveform by generating a series of orthogonal or quasi-orthogonal code words; and digitally multiplying each of a created DSSS composite coded waveform by at least one of the code words of the generated series of orthogonal or quasi-orthogonal code words to produce a newly-coded composite waveform.
